(19) United States
(12) Patent Application Publication
(10) Pub. No.: US 2025/0206295 A1
(43) Pub. Date: Jun. 26, 2025

(54) COMPUTER-IMPLEMENTED METHOD FOR DETERMINING URGENCY IN A DRIVER OF A VEHICLE

(71) Applicants: Continental Automotive Technologies GmbH, Hannover (DE); NANYANG TECHNOLOGICAL UNIVERSITY, Singapore (SG)

(72) Inventors: Avalpreet Singh BRAR, Singapore (SG); Rong SU, Singapore (SG); Han ZHANG, Singapore (SG)

(21) Appl. No.: 18/985,635

(22) Filed: Dec. 18, 2024

(30) Foreign Application Priority Data
Dec. 20, 2023 (GB) 2319696.7

(51) Int. Cl. B60W 30/09; B60W 50/14; G07C 5/02

(52) U.S. Cl. CPC B60W 30/09; B60W 50/14; G07C 5/02; B60W 2050/146; B60W 2520/10; B60W 2520/105; B60W 2554/406; B60W 2555/20; B60W 2556/10; B60W 2710/18; B60W 2720/106

(57) ABSTRACT

The invention proposes a computer-implemented method for determining an urgency score of a driver (12) of a ego vehicle (10) based on contextual information data (26), the method comprising: a) fetching vehicle dynamic data (24) that are indicative of at least one quantity related to the motion of the ego vehicle (10); b) fetching contextual information data (26) that are indicative of at least one property external to the ego vehicle (10); c) generating a feature vector from the vehicle dynamic data (24) and the contextual information data (26); d) classifying the feature vector into an urgency class or a non-urgency class and tracking the amount of occurrences of the urgency class with an anomaly counter; and e) determining an urgency score based on the value of the anomaly counter.

### RELATED APPLICATIONS

This patent application claims priority to United Kingdom Patent Application Number 2319696.7, filed on Dec. 20, 2023, which is incorporated herein by reference. DESCRIPTION

A computer-implemented method for determining urgency in a driver of a vehicle

### TECHNICAL FIELD

The invention relates to a computer-implemented method for determining urgency in a driver of a vehicle and associated methods and systems.

### BACKGROUND

U.S. Pat. No. 10,748,419 B1 discloses a method for generating a vehicle-to-vehicle traffic alert and updating a vehicle-usage profile. Various aspects include detecting, via one or more processors associated with a first vehicle, that an abnormal traffic condition exists in an operating environment of the first vehicle. An electronic message is generated and transmitted wirelessly, via a vehicle-mounted transceiver associated with the first vehicle, to alert a nearby vehicle of the abnormal traffic condition and to allow the nearby vehicle to avoid the abnormal traffic condition. The first vehicle receives telematics data regarding operation of the nearby vehicle after the nearby vehicle received the electronic message, and transmits the telematics data to a remote server for updating a vehicle-usage profile associated with the nearby vehicle.

U.S. 2022/0126840 A1 discloses a method for augmenting transport services using event detection. The method includes collection of first sensor data generated by various sensors associated with a plurality of vehicles. The first sensor data includes sensor outputs that indicate a plurality of rash driving events. The sensor outputs are augmented based on angular rotation to obtain augmented sensor outputs. A prediction model is trained based on the augmented sensor outputs. Target sensor data associated with a target vehicle is provided as input to the trained prediction model, and based on an output of the trained prediction model an occurrence of a rash driving event is detected in real-time or near real-time. Based on a count of rash driving events associated with the target driver within a cumulative driving distance, a driver score of the target driver is determined.

AU 2021 102 962 A4 discloses a system for driver behaviour analysis based on mood detection. Facial image-based expression classification via a convolution neural network is used for driver monitoring. A real-time embedded emotion recognition system is able to detect, exploit and evaluate the emotional state of the driver.

IN 2019 21 028 280 A and IN 2018 41 018 436 A disclose methods for rash driving and overspeed detection.

DE 10 2015 215 400 A1 discloses a method for providing an urgency measure for the situational provision of environmental information to a driver of a motor vehicle. The urgency measure indicates a probability that the driver of the motor vehicle is in a hurry.

### SUMMARY OF THE INVENTION

It is the object of the invention to improve urgency detection during operation of vehicles.

The object is achieved by the subject-matter of the independent claims. Preferred embodiments are subject-matter of the dependent claims.

The invention provides a computer-implemented method for determining an urgency score of a driver of an ego vehicle based on contextual information data, the method comprising:
a) fetching ego vehicle dynamic data that are indicative of at least one quantity related to the motion of the ego vehicle;
b) fetching contextual information data that are indicative of at least one property external to the ego vehicle;
c) generating a feature vector from the vehicle dynamic data and the contextual information data;
d) classifying the feature vector into an urgency class or a non-urgency class and tracking the amount of occurrences of the urgency class with an anomaly counter; and
e) determining an urgency score based on the value of the anomaly counter.

The solution presented herein considers contextual information in addition to other information sources. The classification can be done via supervised, unsupervised, or semi-supervised classification algorithms. Rash driving can be treated as an indicator of driver urgency. By involving the contextual information different causes of anomalous driving behaviour can be considered more reliably. Relevant contextual information includes but is not limited to road congestion, road condition, lane change(s) and cut-in behaviour of nearby drivers. Due to the contextual information typically influencing the driving style of the driver, the classification accuracy of the urgency detection model is affected. The disclosed method can detect driver urgency with greater accuracy and/or reliability by taking into account the contextual information.

Preferably, in step a) the vehicle dynamic data include any of ego vehicle speed, ego vehicle acceleration, and ego vehicle jerk. Ego vehicle speed, acceleration and/or jerk are typically indicative of an urgency while driving. Generally it is assumed that higher speeds, accelerations and jerks are associated with a higher degree of urgency. Consequently, consideration of at least one of these quantities allows for a more accurate and/or reliable determination of the overall urgency.

Preferably, in step b) the at least one property is chosen from any of weather data, congestion data, road condition data, traffic data and vehicle dynamic data of at least another vehicle. These contextual information data can temper or give a more comprehensive understanding of the driving situation. It may be, for example, that congestion or road condition force the ego vehicle driver to slow down, while actually being in urgency. The vehicle dynamic data of other vehicles may also increase the understanding of the current driving situation, e.g., whether the ego vehicle moves on the average faster or slower than other vehicles under the same conditions. Considering all these (and more unmentioned) different circumstances allows for a more accurate and/or reliable determination of the overall urgency.

Preferably, in step c) the feature vector is generated to include any of maximum speed, maximum speed deviation Δv_{avg}, range of the vehicle jerk, maximum acceleration, maximum jerk, geometric mean of the speed deviation Δv_{avg}, maximum acceleration deviation, 3^{rd} quartile speed deviation Δv_{avg}, maximum jerk deviation Δj_{avg}, standard deviation of the acceleration, standard deviation of speed, 3^{rd} quartile acceleration deviation, average acceleration, range of the speed deviation Δv_{avg}, range of the acceleration deviation, and at least one statistical feature extracted from vehicle dynamic data of the ego vehicle and/or of at least another vehicle. Simulations by the applicant have shown, that these quantities are correlated to urgency to a large degree. As a result, picking the more closely correlated quantities may increase accuracy and/or reliability of the determination of the overall urgency.

Preferably, the statistical feature includes any of a speed distribution, acceleration distribution, jerk distribution, a maximum speed distribution, maximum speed deviation Δv_{avg} distribution, range of the car jerk distribution, maximum acceleration distribution, maximum jerk distribution, geometric mean of the speed deviation Δv_{avg} distribution, maximum acceleration deviation distribution, 3^{rd} quartile speed deviation Δv_{avg} distribution, maximum jerk deviation Δj_{avg} distribution, standard deviation of the acceleration distribution, standard deviation of speed distribution, 3^{rd} quartile acceleration deviation distribution, average acceleration distribution, range of the speed deviation Δv_{avg} distribution, range of the acceleration deviation distribution. The consideration of statistical features allows for a better insight into the urgency behaviour of the ego vehicle driver. It is possible, for example, that a particular ego vehicle driver generally drives faster, with more acceleration and/or jerk than another ego vehicle driver. Considering the statistical distribution allows determining of the overall urgency with better accuracy and/or reliability, as the effects of baseline differences in the driving style of the different drivers on the urgency score can be mitigated.

Preferably, in step d) classifying is performed by a supervised binary or multi-class classification method, e.g., a random forest approach, or an unsupervised classification method such as a kernel density estimation method for classifying the feature vector into an urgency class or a non-urgency class. Classification into two classes allows for improved certainty in the assessment. As a result, there can be always a definite determination, whether the driver exhibits urgency or not.

Preferably, the binary classification method and the multi-class classification method output a result indicating a normal state or a result indicating urgency, wherein the multi-class classification method additionally outputs at least one result indicating another class of behaviour of the driver. It is also possible to include further driver states into the evaluation that may or may not be related to urgency or a driving style, such as “rash”, “calm”, etc.

Preferably, the classification method involves a random forest approach or an XGBoost approach. The XGBoost method is described in T. Chen, C. Guestrin, “XGBoost: A Scalable Tree Boosting System”, 2016, available at arXiv: 1603.02754v3. XGBoost stands for extreme Gradient Boosting, and is a highly efficient and versatile algorithm in machine learning, particularly for structured or tabular data. XGBoost belongs to a family of boosting algorithms. Boosting is an ensemble technique where new models are added to correct the errors made by existing models. Models are added sequentially until no further significant improvements can be made. Specifically, XGBoost uses gradient boosting, meaning it uses the gradient descent algorithm to minimize the loss when adding new models. This process involves three elements: a loss function to be optimized, a weak learner to make predictions, and an additive model to add weak learners to minimize the loss function. In particular, XGBoost can automatically handle missing data. When it encounters a missing value, it assigns a direction of the gradient descent for the missing values depending on which direction reduces the loss function more. Another feature of XGBoost is regularization, which can help to prevent overfitting.

This is an advantage over standard implementations. It has both L1 (Lasso regression) and L2 (Ridge regression) regularization. XGBoost uses a depth-first approach and prunes trees backward. Unlike traditional methods, where trees are grown to their full depth and then pruned, XGBoost stops growing the tree when it encounters a negative loss in the split. XGBoost is preferred to efficiently handle sparse data, which is common in many real-world datasets, especially in contexts like classification.

Preferably, in step d) classifying is performed by an unsupervised classification method. Preferably, the classification method involves a kernel density estimation method for classifying the feature vector into an urgency class or a non-urgency class. Kernel density estimation can be faster and more accurate/reliable than other unsupervised classification methods. Due to the comparatively low computational effort, it can be particularly suitable for embedded applications.

Preferably, wherein in step d) the urgency score is determined by a moving average approach that involves dividing the anomaly counter by a current time step that is measured from a beginning of a trip with the ego vehicle. With this, more weight is put on to anomalies that occur in a short window of time. In other words, if the driver exhibits occasional urgent behaviour, it is more unlikely for the driver to be in urgency, whereas, if the driver exhibits multiple occasions of urgent behaviour in a shorter time span, it is more likely for the driver to be in urgency. As a result, the accuracy and/or reliability of the method can be improved.

Preferably, step e) comprises comparing the urgency score with historic urgency score data and determining that the driver is in urgency upon the urgency score exceeding a predetermined threshold, preferably given by the historic urgency score. With this it is possible to account for different driving styles of an ego vehicle driver by comparing the current driving to his/her own historic driving style. Different drivers typically have different driving styles such that what can be considered a more urgent driving style for one driver can be considered regular for another. Consequently, a comparison between the current and historic driving urgency score allows for a more accurate and/or reliable determination of overall urgency.

The invention provides a computer-implemented method for operating a driver assistance system for a vehicle, the method comprising:
performing a previously described method to determine an urgency score, comparing the urgency score with historic urgency score data and determining that the driver is in urgency upon the urgency score exceeding a predetermined threshold given by the historic urgency score;
generating a control signal to cause the vehicle to display a warning message, to increase braking force, to increase sensitivity of collision sensors, and/or to decrease maximum speed and/or acceleration of the vehicle. The preferred method can be implemented into a driver assistance system that can adapt the behaviour of the vehicle to the urgency of the ego vehicle driver.

The invention provides a driver assistance system for a vehicle comprising means for carrying out the previous method.

The invention provides a computer program comprising instructions which, when the program is executed by a computer, cause the computer to carry out the method, or when the program is executed by a driver assistance system, cause the driver assistance system to carry out the method.

The invention provides a computer-readable medium or a data carrier signal comprising the computer program.

In contrast to the known approaches that can classify a driver's driving style into categories such as “normal”, “rash”, “calm” etc. using data of historic drive cycles from various drivers, the present invention considers further information such as contextual information. In the solution presented here, the classification can be done via supervised, unsupervised, or semi-supervised classification algorithms. Rash driving can be treated as an indicator of driver urgency.

By involving contextual information the causes of anomalous driving behaviour can be considered. The relevant factors include but are not limited to road congestion, road condition, lane change(s) and cut-in behaviour of nearby drivers, etc. These factors typically influence the classification accuracy of the urgency detection models. In the disclosed method, an improved method is used to detect driver urgency, where the contextual information is incorporated to make the classification.

In general the disclosed method includes fetching contextual information. There are preferably different sources for contextual information. A source is the on-board device, which is capable of providing vehicle dynamics data, such as vehicle speed, vehicle jerk, or vehicle acceleration.

Another source are sensors of the vehicle, which monitors the surrounding area. The sensor may be camera, ultrasonic sensors or similar sensors that may capture lane change or obstacles (including other vehicles, pedestrians, and the like).

Another possible source is weather data. Weather data can be obtained from the internet, for example, for third party weather information sites.

Another source can be a sensor monitoring the road condition. Alternatively or additionally, the road condition can be obtained from a traffic information service. For example, the road condition can include several classes, such as bumpy, wet, slippery, curved, traffic light, highway, speed limit, etc.

Another source can be traffic data that can be obtained via internet and can be indicative of congestion.

The next step involves classifying the driving-style of the driver. Preferably, the driving-style classification is done to classify the driver as being in an “urgency-class” (sometimes also called the driver behaving “anomalous”) or in a “non-urgency class” (sometimes called the driver behaving “normal”) using a trained classifier and the contextual information collected in the previous step. The trained classifier can be trained in a simulated environment, where test subjects are given different driving situations or tasks and the level of urgency is manually labelled. A supervised classification method that is suitable is using a random decision forest. An unsupervised classification method that is suitable is kernel density estimation (KDE).

After classification an evaluation of the recent results of the classification is performed. The instances of anomalous behaviour are aggregated over time, where preferably a moving average over time is used to determine an urgency score. This urgency score—also called the current urgency score-is used in determining, whether a pattern of urgency persists. The current urgency score is then compared with the driver's historic driving-style. Using a reference distribution of the urgency score, the system determines if the driver is behaving differently compared to the historic data, i.e., whether the driver drives in a more rash manner than usual.

If the rash driving score is above a certain threshold, the driver is classified as being in urgency.

In other words, the pattern of urgency is typically determined to persist, if a threshold (that may be based on historic urgency data of the respective driver) is exceeded by the urgency score.

As an application, if it is determined that the driver is in urgency, a control signal can be generated that causes a driver assistance system to perform different functions. For example, the driver can be informed by displaying a warning message. Another possibility is for the driver assistance system to limit the maximum speed or maximum acceleration of the vehicle. A further possibility is to increase the braking power of the vehicle. Another idea is to set a collision warning system to a more sensitive setting, i.e., that there is an earlier warning and/or possible braking procedure. If applicable, the range in which data is gathered by the vehicle sensors is increased.

Overall it is possible to increase road safety by determining, whether the driver is in urgency, and in response to determining the driver to be in urgency to activate different safety measures that are designed to reduce the risk of a collision or other issue due to the driver being in urgency.

### BRIEF DESCRIPTION OF THE DRAWINGS

Embodiments of the invention are described in more detail with reference to the accompanying schematic drawings. The drawings are listed below.

FIG. 1 depicts a traffic situation;

FIG. 2 depicts a data flow;

FIG. 3 and

FIG. 4 depict diagrams that illustrate a classification method; and

FIG. 5 depicts an embodiment of a method for determining an urgency measure.

### DETAILED DESCRIPTION OF EMBODIMENT

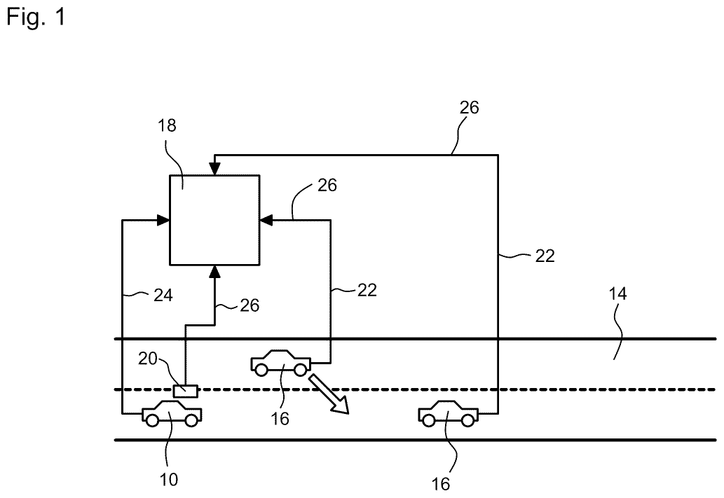

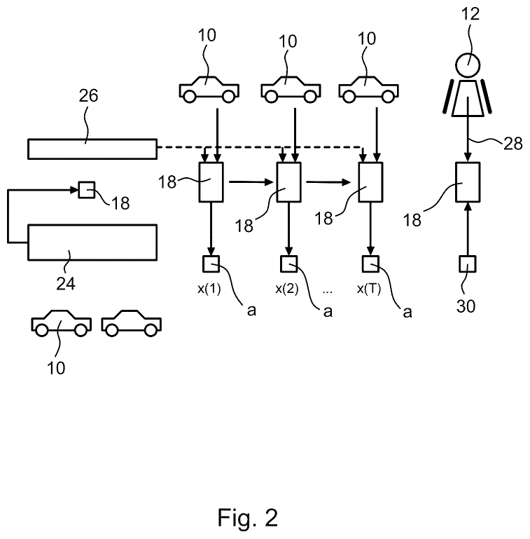

Referring to FIG. 1, a traffic situation is depicted. An ego vehicle 10 is driven by a driver 12 (FIG. 2) on a road 14. Other vehicles 16 are also present during the drive. The driver 12 drives the ego vehicle 10 from a starting point to a destination. The ego vehicle 10 includes a driver assistance system 18. The driver assistance system 18 is shown separately from the ego vehicle 10 for reasons of clarity.

The driver assistance system 18 is coupled to one or more sensors 20 that is installed on the ego vehicle 10. The sensors 20 can be configured as an ultrasonic sensor, an imaging sensor, e.g., a camera, a lidar sensor, a radar sensor, an accelerometer, a speedometer and the like.

Furthermore, the other vehicles 16 have the ability to communicate with the driver assistance system 18 via a telecommunication link 22. The telecommunication link 22 is typical configured to involve other vehicles 16 that are close to the ego vehicle 10.

Furthermore, the driver assistance system 18 can be connected to the internet for other particular data sources, such as weather data, congestion data, traffic data, and/or road condition data.

Referring to FIG. 2, the driver assistance system 18 receives vehicle dynamic data 24 and contextual information data 26. The vehicle dynamic data 24 include quantities that are related to the motion of the ego vehicle 10 and, if applicable, the other vehicles 16, such as speed, acceleration and/or jerk. The vehicle dynamic data 24 may be obtained for a time period of one minute with a data point each second, for example. In this example, the vehicle dynamic data 24 comprises a vector of length 60. It should be noted that the time period and/or sampling interval, i.e., the data points per second, can be varied as suitable.

From these quantities further vehicle dynamic data 24 such as average speed v_{avg}, average road speed v_{avg_road}, average jerk j_{avg}, and average road jerk j_{avg_road} can be extracted.

The contextual information data 26 is indicative of quantities that describe the environment or surrounding area of the ego vehicle 10. Examples for the contextual information data 26 include, but are not limited to weather data, congestion data, traffic data, and road condition data. The sensor data of the sensors 20, in particular the imaging sensors, that monitor the surroundings of the ego vehicle 10 form also part of the contextual information data 26.

Furthermore, the driver assistance system 18 has stored therein a driver profile 28 for each driver 12. The driver profile 28 includes historical urgency data 30 that are indicative of the past driving style of the driver 12 as it relates to urgency and serve as a reference to determine whether the driver 12 is in urgency.

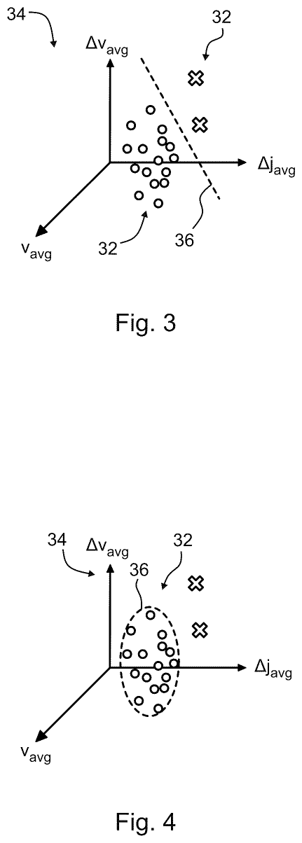

Referring to FIG. 3 and FIG. 4 two classification concepts are described in more detail. The diagrams show data points 32 in a schematic embedding space 34. The data points 32 are characterized by a plurality of features, where each feature forms a dimension of the embedding space 34. The embedding space 34 is exemplified as a three-dimensional space although it will be apparent to the skilled person that the embedding space 34 typically has more dimensions. The embedding space 34 is separated into two classes by a border 36, that separates the classes “non-urgency” (circles) and “urgency” (crosses).

FIG. 3 shows a random forest approach. Random forest is known for its robustness, ability to handle high-dimensional data, resistance to overfitting, and relatively low hyperparameter sensitivity.

A labelled data set is used for training and validation. The labelled data set includes data points 32 that can be obtained by letting different test subjects interact with a simulated environment. The test subjects are given different driving situations or driving tasks. Specifically, the different driving situations and driving tasks can be simulated based on contextual information data 26. For each configuration of contextual information data 26, the vehicle dynamic data 24 generated by the driving of test subject are recorded as the data points 32 during the simulation. Subsequently or during the simulation, the level of urgency is manually labelled. The data points 32 can be recorded in real time or at a given sampling rate of, e.g., 10 seconds, 30 seconds or one minute.

Starting with the labelled dataset, where each data point 32 is associated with a class label, such as non-urgency (circle) and urgency (cross). Random forest introduces randomness in two ways.

First, it randomly selects a subset of the dataset (with replacement) to create multiple training datasets. This process is called “bootstrapping” or “bagging.” Each of these subsets is referred to as a “bootstrap sample.”

For each bootstrap sample, a decision tree is constructed. The decision trees are used for binary classification, i.e., two classes, namely non-urgency and urgency. During training, each tree learns a mapping between the input features that are based on the vehicle dynamic data 24, the contextual information data 26 and the class labels.

At each node of the tree, a random subset of features is considered for splitting. This introduces another layer of randomness and helps prevent overfitting. The tree is grown until a stopping criterion is met, such as a maximum depth or a minimum number of samples per leaf.

After constructing multiple decision trees, the next step is to aggregate their predictions. In the case of classification, each decision tree votes for the class it predicts. For binary classification, the class with the majority of votes becomes the predicted class for the input data point 32.

Random forest includes a built-in evaluation mechanism called out-of-bag (OOB) error. Since each bootstrap sample is created by random sampling, some data points 32 are left out (out-of-bag) during the construction of each tree. The OOB error is calculated by evaluating each data point 32 using only the trees for which it was an out-of-bag sample. This provides an estimate of the model's performance without the need for a separate validation set.

Random forest also provides a measure of feature importance. It calculates the average decrease in impurity (e.g., Gini impurity) caused by each feature across all the decision trees. Features that consistently lead to better splits are considered more important.

FIG. 4 shows a kernel density estimation approach. KDE-based binary classification can capture complex and non-linear relationships in the data. It does not rely on a predefined decision boundary, making it more flexible in handling data with intricate patterns. KDE can be particularly useful when you have prior knowledge about the data distribution or when the data distribution is not easily separable by a linear boundary.

Binary classification with kernel density estimation (KDE) is an approach to classify data points 32 into urgency and non-urgency based on their estimated probability density. The KDE-based classification makes use of the underlying data distribution to make predictions.

Starting again with a labelled dataset containing the non-urgency and urgency datapoints, where each data point 32 a plurality of features. For training, the dataset is split into a training set and a testing set to evaluate the classifier's performance.

For each class an independent estimate of a probability density function (PDF) using KDE involves selecting a kernel function (e.g., Gaussian or Epanechnikov), choosing an appropriate bandwidth parameter to control the width of the kernels, and calculating the KDE for each class based on the respective training data. The bandwidth parameter can be chosen using techniques like cross-validation.

During operation the KDE is fed with features based on the vehicle dynamic data 24 and the contextual information data 26 and for each data point 32 the probability density for that data point 32 is calculated under each of the two class-specific KDEs. This results in one density value for each class.

To classify the measured data point 32 is compared with the two density values. The point is assigned to the class with the higher estimated probability density. In other words, if the density estimate non-urgency is higher, the data point 32 is classified as the class “non-urgency”; otherwise, it is classified as class “urgency”.

To evaluate the performance of the KDE classifier it is applied to the testing dataset and the predictions are compared to the true class labels. Preferably standard classification metrics such as accuracy, precision, recall, F1-score, and ROC curves are used to assess the KDE classifier performance.

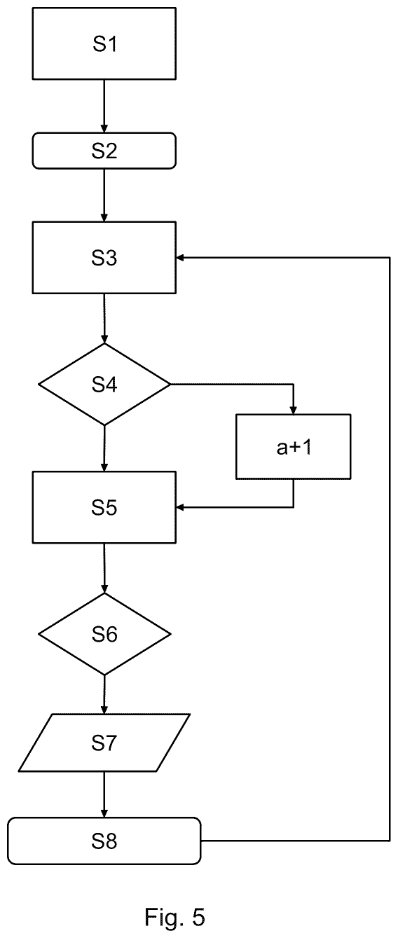

Referring FIG. 5, a method for determining an urgency score of a driver. The method is preferably carried out by the driver assistance system 18.

In a preparation step S1 a trained classifier, e.g., the random forest classifier or the KDE classifier, is loaded. Furthermore, an anomaly counter ‘a’ is initialized as a=0 and a time counter k is initialized as k=1.

In a starting step S2 the driver assistance system 18 starts operation.

In a data gathering step S3, the driver assistance system 18 fetches the sensor data from the sensor 20 and the vehicle dynamic data. If applicable, the driver assistance system 18 also fetches contextual information data 26 via the telecommunication link 22 from the other vehicles 16 and/or the internet. The contextual information data 26 includes vehicle dynamic data, but of the other vehicles 16 and/or additional information, such as congestion data, weather data, traffic data, and road condition data. The vehicle dynamic data and the contextual information data 26 are gathered roughly every minute.

In the data gathering step S3, feature extraction is performed on the vehicle dynamic data 24 and contextual information data 26. It is possible to construct a feature vector by concatenating the vehicle dynamic data 24 and contextual information data 26. The feature vector preferably is based on speed, acceleration and/or jerk. the average speed v_{avg} of the ego vehicle 10, the average jerk j_{avg} of the ego vehicle 10, the speed deviation Δv_{avg} of the average speed v_{avg} of the ego vehicle 10 from the average road speed v_{avg_road}, and the jerk deviation Δj_{avg} of the average jerk j_{avg} of the ego vehicle 10 from the average road jerk j_{avg_road}.

The following features may also be suitable for the disclosed application: maximum speed, maximum speed deviation Δv_{avg}, range of the vehicle jerk, maximum acceleration, maximum jerk, geometric mean of the speed deviation Δv_{avg}, maximum acceleration deviation, 3^{rd} quartile speed deviation Δv_{avg}, maximum jerk deviation Δj_{avg}, standard deviation of the acceleration, standard deviation of speed, 3^{rd} quartile acceleration deviation, average acceleration, range of the speed deviation Δv_{avg}, and range of the acceleration deviation.

In a classifying step S4, the feature vector is classified by the trained classifier. If the classifier determines an anomaly, the anomaly counter ‘a’ is increased by one, otherwise the anomaly counter ‘a’ remains unchanged.

In a scoring step S5, an urgency score z is determined by dividing the current value of the anomaly counter ‘a’ by the current time step k, or written as a formula z=a/k. Subsequently, the time step k is increased by one.

In a comparison step S6, the current urgency score z is compared to historic urgency score distribution Uᵢ(z), where i identifies the driver 12. If a predetermined threshold is exceeded by the current urgency score z, the driver assistance system 18 determines the driver 12 to be in urgency.

In a control step S7, a control signal is generated based on the result of the comparison step S6. If the driver 12 is determined not to be in urgency, the control signal does not change the behaviour of the driver assistance system 18 or the ego vehicle 10. If the driver 12 is determined to be in urgency, the control signal is generated to cause the driver assistance system 18 to warn the driver 12 of his driving style by displaying a warning. It is also possible for the control signal to cause the driver assistance system 18 to limit the maximum speed and/or acceleration of the ego vehicle 10, to increase the sensitivity of collision detection, and/or to increase the braking force.

In a finishing step S8, the driver assistance system 18 loops back to the data gathering step S3, unless the driver 12 turns off the ego vehicle 10, for example.

### REFERENCE SIGNS

10 ego vehicle
12 driver
14 road
16 other vehicle
18 driver assistance system
20 sensor
22 telecommunication link
24 vehicle dynamic data
26 contextual information data
28 driver profile
30 historical urgency data
32 data point
34 embedding space
36 border

What is claimed is:

1. A computer-implemented method for determining an urgency score of a driver of an ego vehicle based on contextual information data, the method comprising:
a) fetching vehicle dynamic data that are indicative of at least one quantity related to the motion of the ego vehicle;
b) fetching contextual information data that are indicative of at least one property external to the ego vehicle;
c) generating a feature vector from the vehicle dynamic data and the contextual information data;
d) classifying the feature vector into an urgency class or a non-urgency class and tracking the amount of occurrences of the urgency class with an anomaly counter; and
e) determining an urgency score based on the value of the anomaly counter.

2. The method according to claim 1, wherein in step a) the vehicle dynamic data include any of ego vehicle speed, ego vehicle acceleration, and ego vehicle jerk.

3. The method according to claim 1, wherein in step b) the at least one property is chosen from any of weather data, congestion data, road condition data, traffic data and vehicle dynamic data of at least another vehicle.

4. The method according to claim 1, wherein in step c) the feature vector is generated to include any of maximum speed, maximum speed deviation Δv_{avg}, range of the vehicle jerk, maximum acceleration, maximum jerk, geometric mean of the speed deviation Δv_{avg}, maximum acceleration deviation, 3^{rd} quartile speed deviation Δv_{avg}, maximum jerk deviation Δj_{avg}, standard deviation of the acceleration, standard deviation of speed, 3^{rd} quartile acceleration deviation, average acceleration, range of the speed deviation Δv_{avg}, and range of the acceleration deviation, and at least one statistical feature extracted from vehicle dynamic data of the ego vehicle and/or of at least another vehicle.

5. The method according to claim 1, wherein in step d) classifying is performed by a supervised binary or multi-class classification method, wherein the binary classification method and the multi-class classification method output a result indicating a normal state or a result indicating urgency, wherein the multi-class classification method additionally outputs at least one result indicating another class of behaviour of the driver.

6. The method according to claim 5, wherein the classification method involves a random forest approach or an XGBoost approach.

7. The method according to claim 5, wherein in step b) the at least one property is chosen from any of weather data, congestion data, road condition data, traffic data and vehicle dynamic data of at least another vehicle.

8. The method according to claim 5, wherein in step c) the feature vector is generated to include any of maximum speed, maximum speed deviation Δv_{avg}, range of the vehicle jerk, maximum acceleration, maximum jerk, geometric mean of the speed deviation Δv_{avg}, maximum acceleration deviation, 3rd quartile speed deviation Δv_{avg}, maximum jerk deviation Δj_{avg}, standard deviation of the acceleration, standard deviation of speed, 3rd quartile acceleration deviation, average acceleration, range of the speed deviation Δv_{avg}, and range of the acceleration deviation, and at least one statistical feature extracted from vehicle dynamic data of the ego vehicle and/or of at least another vehicle.

9. The method according to claim 1, wherein in step d) classifying is performed by an unsupervised classification method.

10. The method according to claim 9, wherein the classification method involves a kernel density estimation method for classifying the feature vector into an urgency class or a non- urgency class.

11. The method according to claim 9, wherein in step b) the at least one property is chosen from any of weather data, congestion data, road condition data, traffic data and vehicle dynamic data of at least another vehicle.

12. The method according to claim 9, wherein in step c) the feature vector is generated to include any of maximum speed, maximum speed deviation Δv_{avg}, range of the vehicle jerk, maximum acceleration, maximum jerk, geometric mean of the speed deviation Δv_{avg}, maximum acceleration deviation, 3rd quartile speed deviation Δv_{avg}, maximum jerk deviation Δj_{avg}, standard deviation of the acceleration, standard deviation of speed, 3rd quartile acceleration deviation, average acceleration, range of the speed deviation Δv_{avg}, and range of the acceleration deviation, and at least one statistical feature extracted from vehicle dynamic data of the ego vehicle and/or of at least another vehicle.

13. The method according to claim 1, wherein in step d) the urgency score is determined by a moving average approach that involves dividing the anomaly counter by a current time step that is measured from a beginning of a trip with the ego vehicle.

14. The method according to claim 13, wherein in step b) the at least one property is chosen from any of weather data, congestion data, road condition data, traffic data and vehicle dynamic data of at least another vehicle.

15. The method according to claim 1, wherein step e) comprises comparing the urgency score with historic urgency score data and determining that the driver is in urgency upon the urgency score exceeding a predetermined threshold.

16. A computer-implemented method for operating a driver assistance system for an ego vehicle, the method comprising:
performing a method according to claim 1 to determine an urgency score, comparing the urgency score with historic urgency score data and determining that the driver is in urgency upon the urgency score exceeding a predetermined threshold given by the historic urgency score; and
generating a control signal to cause the ego vehicle to display a warning message, to increase braking force, to increase sensitivity of collision sensors, and/or to decrease maximum speed and/or acceleration of the ego vehicle.

17. A driver assistance system for an ego vehicle comprising means for carrying out the method according to claim 16.

18. A ego vehicle comprising a driver assistance system according to claim 17.

19. A computer-readable medium comprising non-transitory instructions which, when executed by a computer, cause the computer to carry out the method according to claim 1.

20. A computer-readable medium comprising non-transitory instructions which, when executed by a driver assistance system, cause the driver assistance system to carry out the method according to claim 16.
